(19) United States
(12) Patent Application Publication
(10) Pub. No.: US 2014/0084809 A1
(43) Pub. Date: Mar. 27, 2014

(54) VARIABLE-BEAM LIGHT SOURCE AND RELATED METHODS

(71) Applicant: Anthony W. Catalano, Boulder, CO (US)

(72) Inventor: Anthony W. Catalano, Boulder, CO (US)

(21) Appl. No.: 14/035,027

(22) Filed: Sep. 24, 2013

Related U.S. Application Data
(60) Provisional application No. 61/704,717, filed on Sep. 24, 2012.
(60) Provisional application No. 61/844,156, filed on Jul. 9, 2013.

(51) Int. Cl. H05B 33/08

(52) U.S. Cl. CPC H05B 33/0845
USPC 315/292; 315/295

(57) ABSTRACT

Light sources with arrangements of multiple LEDs (or other light-emitting devices) disposed at or near the focus of a reflecting optic and controllable individually or in groups facilitate varying the angular distribution of the light beam (e.g., the beam divergence) via the drive currents supplied to the LEDs.

### CROSS-REFERENCE TO RELATED APPLICATION

This application claims priority to and the benefit of, and incorporates herein by reference in their entireties, U.S. Provisional Application Nos. 61/704,717, filed on Sep. 24, 2012, and 61/844,156, filed on Jul. 9, 2013.

### TECHNICAL FIELD

The present invention relates generally to adjustable light sources, and in various embodiments more specifically to light sources comprising multiple individually controllable light-emitting diodes (LEDs).

### BACKGROUND

Light-emitting diodes (LEDs), particularly white LEDs, have increased in size in order to provide the total light output needed for general illumination. As LED technology has advanced, the efficacy (measured in lumens/Watt) has gradually increased, such that smaller die now produce as much light as was previously created by emission from far larger die areas. Nonetheless, the trend favoring higher light outputs has led to larger semiconductor LED die sizes, or, for convenience, arrays of smaller die in series or series-parallel arrangements. Series arrangements are generally favored because the forward voltage of LEDs varies slightly, resulting, for parallel arrangements, in an uneven distribution of forward currents and, consequently, uneven light output.

For many applications, it is desirable to have a light source that produces a light beam whose angular distribution can be varied. Variability is needed, for example, to create a wide-angle light beam for illuminating an array of objects, or a narrow-angle beam for illuminating a single, small object. Conventionally, the angular distribution is varied by moving the light source(s) (e.g., the LED arrangement) toward or away from the focal point of a lens or parabolic minor. As the light source is moved away from the focal point, its image is blurred, forming a wider beam. Unfortunately, in doing so, the image is degraded, becoming very non-uniform; in the case of the familiar parabolic reflector used in flashlights, a dark “donut hole” is formed, which is visually undesirable and sacrifices full illumination of the scene. Furthermore, moving the lens often reduces the collection efficiency of the lens, as light that is not refracted by a lens or reflected by a reflector surface is lost.

Because of these optical artifacts and efficiency losses, most light sources use a single, fixed lens. For light bulbs such as, e.g., MR-16 halogen bulbs, several different types of optics are manufactured to create beams of various beam divergences, ranging from narrow beam angles (“spot lights”) to wide angles (“flood lights”), with various degrees in between. Unless the user maintains different light bulbs on hand to accommodate all potentially desired beam divergences, however, he will generally be limited to one or a small number of alternatives. Traveling with an assortment of bulbs for portable light sources is even less realistic. As a result, users often tolerate either a source ill-suited to changing or unexpected conditions, or the poor optical quality of light sources with variable beam optics. A need, therefore, exists for light sources that produce variable beam angles without sacrificing beam quality.

### SUMMARY

Embodiments of the present invention provide light sources that include an arrangement of individually controllable light-emitting devices (or individually controllable groups of light-emitting devices) fixedly located relative to (typically at or near the focus of) a concave reflecting optic and oriented to face in the same direction as the optic. These light sources can achieve variable beams by selectively driving the individual (groups of) light-emitting devices, e.g., depending on their distance from the center of the arrangement. For example, by turning on only light emitters at or near the center, a narrow beam of light is created, while turning on light emitters throughout the arrangement will create a wider-angle beam. Thus, beam divergence can be adjusted without physically moving the light-emitting devices relative to the optic, eliminating the degradation of the beam associated with too large a separation from the focus.

In various advantageous embodiments, the light-emitting devices are LEDs. However, other types of light emitters, such as, e.g., laser, incandescent, fluorescent, halogen, or high-intensity discharge lights, may also be used. The optic may generally be any suitably shaped reflector, whether implemented as a (glass-metal, dielectric, or other) mirror surface or a total internal reflector (TIR) (i.e., a solid structure, transmissive to light, whose interior surface reflects light incident thereon at an angle greater than a certain critical angle). In certain embodiments, a parabolic reflector is used, but spherical or other curved surfaces may also be employed. The aperture of the reflector is generally larger in diameter than the arrangement of light-emitting devices, in some embodiments by a factor of at least two; advantageously, a large aperture captures a large fraction of the light emitted from the light-emitting devices. The reflector and arrangement of the light-emitting devices are configured to create a directed, yet generally not completely collimated light beam, i.e., a beam of reflected light having non-zero divergence and an angular distribution that covers substantially less than 180° (e.g., in various embodiments, less than about 120°, less than about 90°, or less than about 60°). The beam divergence generally results from the spatial extent of the light-emitting arrangement (and is sometimes enhanced by “spherical aberrations” (broadly understood) of any non-parabolic reflector); the larger the light-emitting arrangement is relative to the focal length of the reflector, the greater is typically the beam divergence. Advantageously, the non-zero beam divergence tends to entail greater beam uniformity, as any non-uniformities in the light-emitting arrangement will be blurred; in some embodiments, this effect is deliberately enhanced by faceting the reflector.

Accordingly, in a first aspect, the invention pertains to a light source producing a beam of variable divergence. In various embodiments, the light source includes a concave reflecting optic, an (e.g., planar) arrangement of light-emitting devices (such as, e.g., LEDs) disposed fixedly relative to and oriented to face in the same direction as the reflecting optic, and driver circuitry for controlling drive currents to the light-emitting devices individually for each device or each of multiple groups of the devices. Light emitted by the light-emitting devices and reflected by the optic forms a light beam whose divergence can be variably controlled by controlling the drive currents.

The arrangement of light-emitting devices may be disposed substantially at a focus of the reflecting optic. As used herein, the “focus” of the reflecting optic refers to the point at which collimated light incident on the reflector parallel to its optical axis and reflected therefrom has its intensity maximum. A parabolic reflector, for instance, has a “true” focal point where all reflected rays (of rays incident on the reflector parallel to the optical axis) intersect. For nonparabolic reflectors, such as spherical reflectors, the reflected rays do not all intersect at the same point, but generally go through the same region (whose boundary may be defined, e.g., by a catacaustic), resulting in an intensity maximum at some point, which is herein considered the focus. An arrangement of light-emitting devices is deemed “substantially at the focus” if the center of the arrangement substantially coincides with the focus, meaning that the center is separated from the focus by no more than 10% (and, in some embodiments, by no more than 5%) of the focal length of the optic (i.e., the distance between the focus and the center of the reflector).

In some embodiments, the optic is or includes a parabolic reflector; in this case, the arrangement of light-emitting devices may be disposed substantially at a focal plane of the parabolic reflector (i.e., a plane through the focus). In other embodiments, the reflector is spherically, conically, or otherwise shaped. The reflecting optic may be faceted and/or textured. In various embodiments, the diameter of the reflecting optic is larger than (e.g., at least twice as large as) the width of the arrangement of light-emitting devices. The width of the arrangement of light-emitting devices, in turn, may be larger than (e.g., at least twice as large as) the focal length of the reflecting optic. In some embodiments, a light-emitting device located at the center of the arrangement is a higher-power device than one or more light-emitting devices located at a periphery of the arrangement.

The driver circuitry may be configured to control the drive currents to the light-emitting devices based on their respective positions and/or sizes (or the positions and/or sizes of groups of the devices). In some embodiments, the driver circuitry controls the drive currents based on the distance of the light-emitting devices from the center of the arrangement. For example, the circuitry may be configured to narrow the beam by providing non-zero drive currents only to light-emitting devices within a specified distance from the center. The circuitry may, further, be configured to uniformly vary the drive currents to all light-emitting devices to thereby vary the intensity of the beam, and/or to selectively drive a subset of the light-emitting devices so as to generate a pattern. In some embodiments, the circuitry is programmable.

In another aspect, the invention relates to a method of varying the divergence of a light source. The light source includes a concave reflecting optic (such as, e.g., a parabolic reflector) and, disposed fixedly relative to and oriented to face in the same direction as the reflecting optic, an arrangement of individually controllable light-emitting devices (such as, e.g., LEDs) or individually controllable groups of such devices. The method includes driving the light-emitting devices so as to create a light beam emerging from the focusing optic, and controlling the drive currents to the light-emitting devices based, at least in part, on their distance from a center of the arrangement so that the beam has a divergence variably determined by the controlled drive currents. Controlling the drive currents may involve decreasing the drive currents to LEDs in an outer region of the arrangement to thereby narrow the beam. The method may further include simultaneously and uniformly varying the drive currents to all LEDs to thereby vary the beam brightness. In some embodiments, the method includes programming driver circuitry for controlling the drive currents.

### BRIEF DESCRIPTION OF THE DRAWINGS

The foregoing will be more readily understood from the following detailed description of the invention, in particular, when taken in conjunction with the drawings, in which:

FIG. 1A schematically illustrates the components of a light source in accordance with various embodiments;

FIG. 1B illustrates various dimensions of the light source of FIG. 1A;

FIG. 1C illustrates a version of the light source of FIG. 1A that includes a TIR optic with a central lens in accordance with various embodiments;

FIGS. 1D and 1E illustrate how narrow and wide beam angles, respectively, can be created by activating fewer or more of the light-emitting devices of the light source of FIG. 1A in accordance with various embodiments;

FIGS. 2A-2C illustrate various exemplary arrangements of LEDs in accordance with various embodiments;

FIGS. 3A and 3B illustrate a faceted parabolic reflector in accordance with various embodiments;

FIG. 3C shows, for the reflector of FIGS. 3A and 3B, plots of the computed center-beam brightness and divergence angle of the output beam as a function of the number of activated LEDs in accordance with various embodiments;

FIG. 4A illustrates an LED arrangement in accordance with various embodiments;

FIG. 4B shows the computed intensity profile of an output beam generated with the LED arrangement of FIG. 4A and a parabolic reflector in accordance with various embodiments;

FIG. 4C shows a plot of the computed center-beam brightness and divergence angle of the output beam generated with the LED arrangement of FIG. 4A and a parabolic reflector in accordance with various embodiments;

FIG. 4D shows the computed intensity profile of an output beam generated with the LED arrangement of FIG. 4A and a conical reflector in accordance with various embodiments;

FIG. 4E shows a plot of the computed center-beam brightness and divergence angle of the output beam generated with the LED arrangement of FIG. 4A and a conical reflector in accordance with various embodiments; and

FIG. 5 schematically illustrates an exemplary implementation of the control functionality for light sources in accordance with various embodiments.

### DETAILED DESCRIPTION

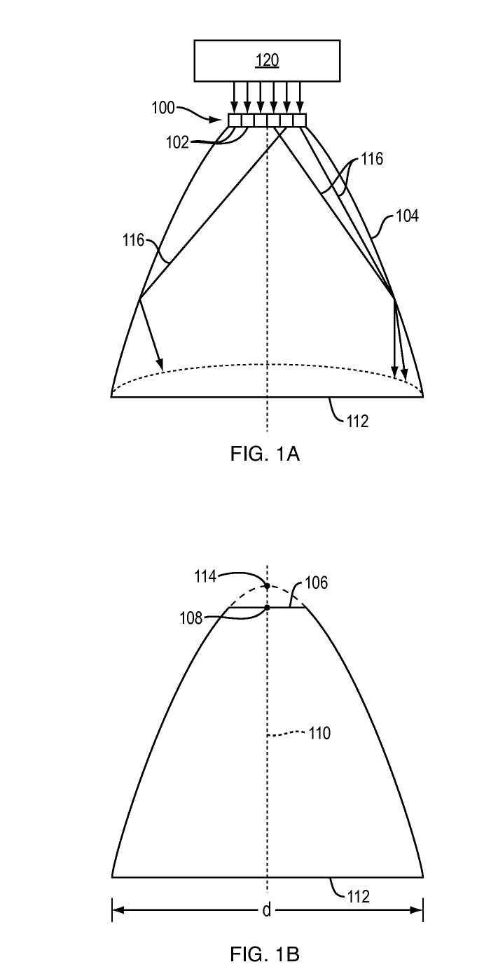

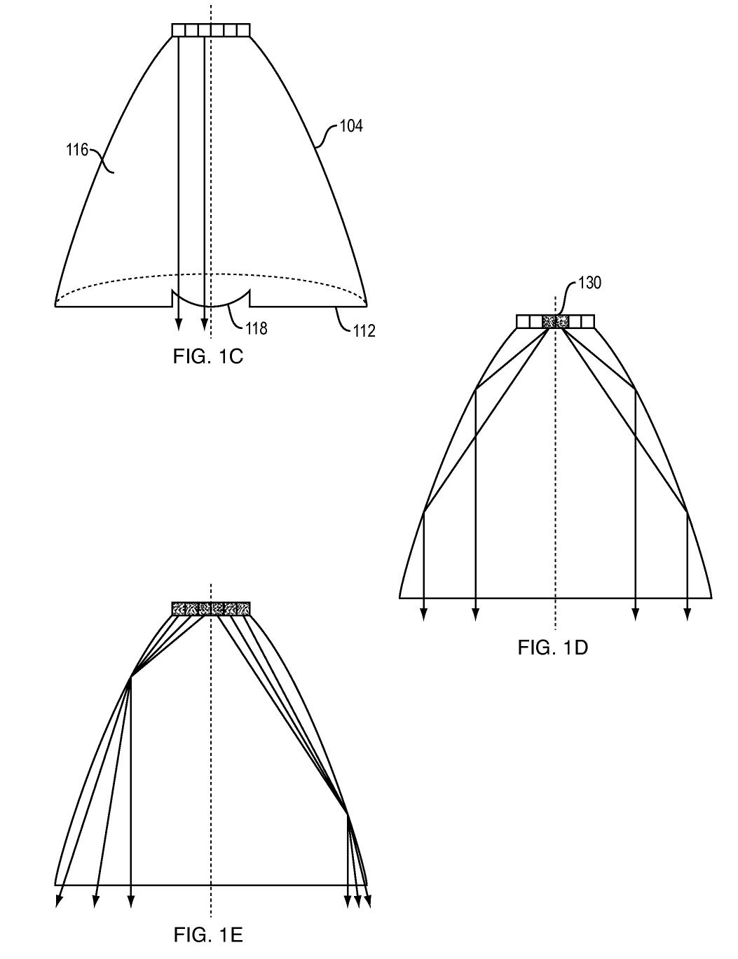

Variable-beam light sources in accordance herewith generally include an arrangement of multiple light-emitting devices disposed, typically, at or near the focus of an optical reflector. FIG. 1A conceptually illustrates an exemplary embodiment that utilizes a planar array 100 of LEDs 102 and a parabolic reflector 104 (i.e., a reflecting optic whose reflective surface forms a truncated paraboloid). The array 100 is placed at the focal plane 106 of the paraboloid (i.e., with reference to FIG. 1B, a plane through the focal point 108 that is perpendicular to the optical axis 110, or symmetry axis, of the paraboloid), and is oriented so as to face in the same direction as the parabolic reflector 104, i.e., such that it emits light towards the aperture 112 of the reflector 104 (corresponding to a cross-section where the paraboloid is truncated), away from the vertex 114 of the paraboloid. Since light emitted from the LED array 102 does not reach the portion of the parabolic surface that lies between the focal plane 106 and the vertex 114, the reflector 104 may also be truncated at the focal plane 106. In TIR embodiments, where the reflector 104 is a solid structure, truncation is generally necessary to place the LED array 100 at the focal plane 106; the paraboloid's cross-section through the focal plane forms, in this case, an entry surface of the optic against which the LED array 100 can be placed. The aperture 112 of the TIR optic constitutes the exit surface.

The LED array 100, which is typically (but not necessarily) positioned symmetrically within the reflector 104 such that its center coincides with the optical axis 110, may extend all the way to the surface of the reflector 104, or be of smaller dimensions. Either way, the diameter d of the aperture 112 of the reflector 104 is greater than the largest dimension 1 of the array 100 (e.g., the diameter of a circular arrangement or the diagonal of a rectangular arrangement). In various embodiments, the aperture diameter d exceeds the array size 1 by a factor of at least two, three, or more. Larger ratios are usually desired because, in general, the larger the reflector aperture 112 is compared with the LED array 100, the more of the emitted light is captured by the reflector 104 and the brighter is the reflected beam. As shown in FIG. 1A, light rays 116 from the array 110 that are incident upon the parabolic reflective surface are generally reflected at an angle directing them more towards the optical axis 110. Thus, the light emitted by the array 100 into a large solid angle (e.g., according to a Lambertian distribution, in which the luminous intensity is proportional to the cosine between the observer's line of sight and the optical axis) is partially collimated so as to form a directed output beam. Light that leaves the aperture 112 directly without striking the reflective surface, however, generally retains its large divergence and may, therefore, not (or not significantly) contribute to the output beam. To capture this centrally emitted light, some embodiments include a central lens along the optical axis. For example, a TIR optic as depicted in FIG. 1C may include a collimating lens surface 118 recessed (as shown) or protruding from the exit surface 112. Such a lens surface 118 may result in an increased central beam intensity of the output beam.

In various embodiments hereof, the LEDs 102 are individually addressable, or addressable in multiple groups (each having a plurality of devices), with suitable driver circuitry 120 (shown in FIG. 1A), facilitating their selective activation and de-activation as well as control over the brightness levels of individual LEDs or groups of LEDs via the respective drive currents. Groups of LEDs may be formed by electrically connecting multiple individual LED die such that the LEDs within the group are all driven by the same current (in a series arrangement) or by approximately equal currents (in a parallel arrangement). In some embodiments, each group contains a (typically small) number of LEDs that adjacent or close to each other (e.g., four LEDs arranged in a square). In other embodiments, LEDs are grouped strategically based, e.g., on the LEDs' distance from the center of the arrangement; for example, each group may consist of LEDs arranged approximately in a circle.

The output beam of such a light source can be varied in divergence angle (which may be defined, e.g., based on the distance from the beam center at which the intensity or the luminous intensity has fallen to 50% of the (luminous) intensity at the center) by driving the individual (groups of) LEDs depending on their distance from the center of the arrangement. The underlying operational principle is illustrated in FIGS. 1D and 1E. As shown, light emitted from the center 130 of the LED array 100 and incident upon the reflector 104 is reflected in a direction parallel to the optical axis 110. Light emitted from off-axis LEDs 102, however, is reflected at an angle relative to the optical axis 110, resulting in divergence of the output beam. The greater the distance of the point of origin within the LED array 100 from the center 130 is, the larger is generally the angle between the reflected ray and the optical axis 110. Consequently, as more and more LEDs 102 are turned on, starting from the center of the array 100—in other words, as the effective size of the array 100 increases—the output-beam divergence likewise increases. For example, with reference to FIG. 1D, if only the two central LEDs of a row of six LEDs (or, for a corresponding two-dimensional LED arrangement, the four central LEDs of a 6×6 array) are turned on, a narrow-angle beam is created. Turning on all six LEDs (or, in the two-dimensional arrangement, all 36 LEDs, i.e., the entire array), by contrast, results in a broader-angle beam, as illustrated in FIG. 1E. The largest beam divergence achievable with a given light source depends on the dimensions of the light-emitting array 100, or, more specifically, the ratio of a linear dimension (e.g., the largest dimension 1, or the width) of the array to the focal length f of the paraboloid, larger ratios typically resulting in greater divergence. In various embodiments, the largest dimension of the array is greater than the focal length, e.g., by a factor of at least two, at least three, or at least four.

Arrangements of LEDs that addressable individually of in groups, for use in embodiments hereof, may be fabricated in various ways. In some embodiments, the LED arrangement is formed of a plurality of so-called “flip-chip” LEDs, which, advantageously, enable the package used to hold the semiconductor die to be reduced to little more than the size of the die itself. These LEDs, in which the electrical contacts are all on one surface of the semiconductor die, eliminate the gold bond wires that take up valuable “real estate” surrounding the die itself, and thus require a larger package, in older types of LEDs. Because the package is a significant contributor to the overall cost of an LED, flip-chip LEDs also help to reduce cost. An example of a commercially available flip-chip product is Philips Lumileds Luxeon Z (from Philips Lumileds Lighting Company), in which the die and package are nearly identical in size and occupy an area of only 2.2 mm². These packaged LEDs have electrical contacts on the back, and can, as a result, be placed very close together. Despite their small size, they produce a considerable amount of light, with each die capable of in excess of 100 lumens. The flip-chip LEDs may be soldered onto a conventional printed circuit board (PCB) that provides the driver circuitry 120 for addressing the individual LEDs (or groups of LEDs); the PCB may be fabricated, e.g., using conventional silk-screen patterning technology as is well-known to persons of skill in the art.

Alternatively, in some embodiments, the LED array 100 and associated conducting traces and the driver circuitry 120 are fabricated on a single substrate made of, for example, a semiconductor (e.g., a silicon wafer) or a ceramic material, as described in detail in U.S. Provisional Application No. 61/844,156, filed on Jul. 9, 2013. The LEDs and driver circuitry on the substrate may be fabricated using, for example, semiconductor photolithography techniques, allowing closer spacing of the LED die than is achievable on traditional PCBs, (thereby reducing optical artifacts arising from the separation between the LEDs). The LEDs may be fabricated in situ with the driver circuitry 120. For example, a III-V semiconductor material or compound may be bonded to or deposited onto a silicon wafer, and thereafter be processed to form the LED die. Alternatively, the individual LED die may be formed separately and subsequently bonded to the substrate. The substrate may include one or more doped layers embedded therein to form n-type and p-type contacts. Vias connecting the LEDs to the n-type and p-type contacts may be fabricated using well-established silicon fabrication methods (e.g., through-silicon vias formed by etching of the silicon material and deposition of a metallic or other conductive layer into the etched regions). Alternatively, the (silicon or other) substrate may be patterned to form metallized pads thereon. Photolithography may be used to define fine conducting lines that address each LED (or group of LEDs); and preformed LED die may then be placed onto (or near) and connected with the metallized pads on the substrate. These procedures provides for high-resolution LED packing with flexibility to address the LEDs individually (or in groups).

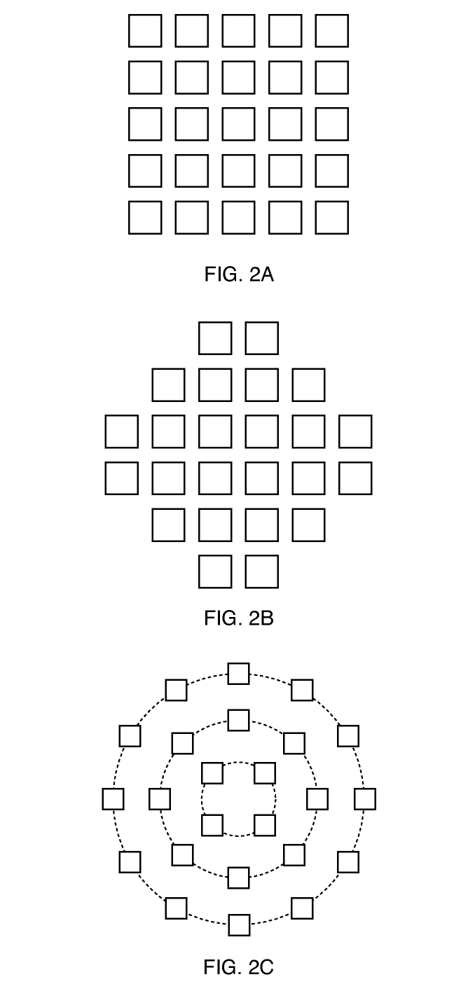

Arrangements of LEDs (or other light-emitting devices) in accordance herewith may vary in shape, size, and configuration. In some embodiments, the LEDs are arranged in a regular array forming a number of rows and columns. The array may be rectangular, as shown in FIG. 2A for 25 LEDs arranged in a 5×5 array, or approximate the typically circular opening of the optic by containing fewer LEDs in the upper and lower rows, as shown in FIG. 2B for a total of 24 LEDs arranged in six rows and six columns. Alternatively, the LEDs may be positioned along concentric circles, as illustrated in FIG. 2C for 24 LEDs, or in any other regular or irregular fashion. The spacing between the arrays may vary depending on the fabrication method employed and the requirements of the particular application. In some embodiments, the individual LEDs have dimensions of 1.1 mm×1.1 mm, and the packaged LED measures about 1.3 mm×1.7 mm. Multiple such LED die may be arranged on the substrate or PCB at center-to-center distances of between 1.5 mm and about 2 mm.

Further, the LEDs need not necessarily be placed on a flat substrate, but may be arranged on a curved surface (e.g., a spherical “cap”); not limiting the LEDs to a single plane may provide greater flexibility in tailoring the beam divergence and beam profile as a function of the number (or selection) of LEDs within the arrangement that are activated. For example, an LED arrangement placed with its center at the focus of a parabolic reflector may achieve greater beam divergence, compared with a flat configuration, if it curved convexly when viewed from a direction facing the concave reflective surface of the optic, and a smaller beam divergence if it is curved concavely.

A parabolic reflector generally creates, at long distances (theoretically at infinity), an image of an object located at its focus. Thus, the non-uniformities in the LED arrangement—i.e., the intensity contrast between the LED die and the gaps therebetween—are typically visible in the output beam. Even in theory, however, only a point source at the focus is imaged perfectly; for an extended light-emitting structure, such as the LED arrangement, the images of the individual LEDs generally overlap (due to the beam divergence), blurring their boundaries. In many applications, this effect is desirable, as it results in greater uniformity of the beam. The effect may be further enhanced by faceting the reflector, i.e., by approximating the curved reflective surface with multiple (usually planar) segments. Typically (but not necessarily), the optic is faceted in two dimensions: vertically, i.e., along the (parabolic) intersections of planes through the optical axis with the paraboloid, and azimuthally, i.e., along the (circular) intersections of planes perpendicular to the optical axis with the paraboloid, resulting in multiple planar quadrilateral segments whose corners lie on the paraboloid. Each facet creates a divergent beam even for light originating directly from the focus; the overlap of the individual divergent beams from all the facets may result in relatively uniform illumination. In TIR optics with central lenses, the lens surface may likewise be faceted or, alternatively, textured at smaller scales. Faceted and/or textured optics are particularly useful with LED arrays that have a dark spot at the center, resulting from the intersection of the vertical and horizontal gaps between adjacent columns and rows of LEDs; without faceting, this dark spot would result in an undesirable hole in the center of the output beam. Faceted optics and the resulting beam characteristics are described in more detail in U.S. patent application Ser. No. 13/606,106, filed on Sep. 7, 2012, the entire disclosure of which is hereby incorporated herein by reference.

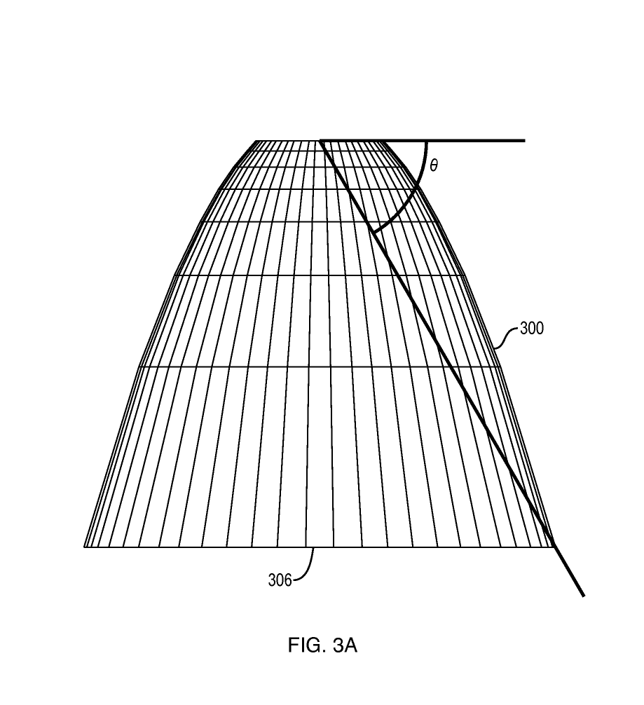

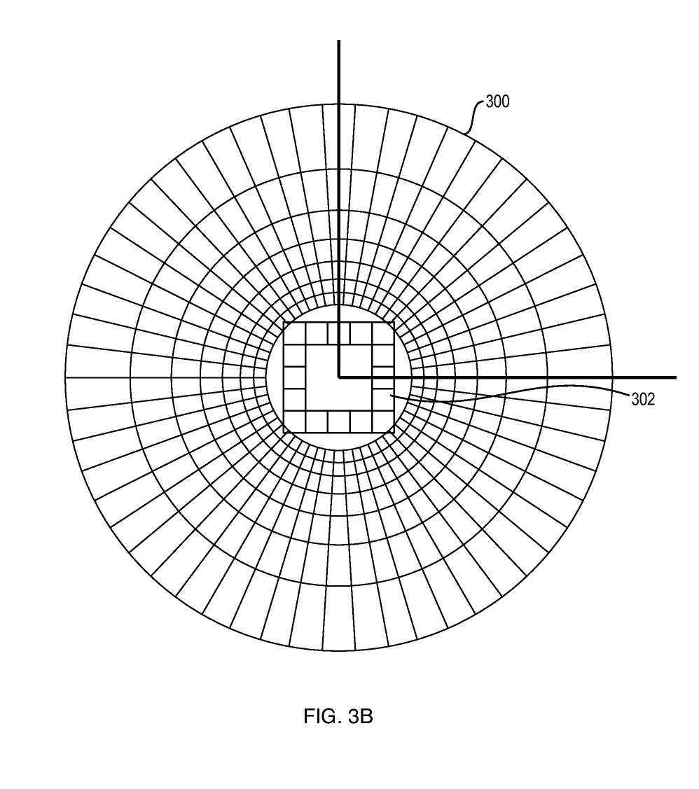

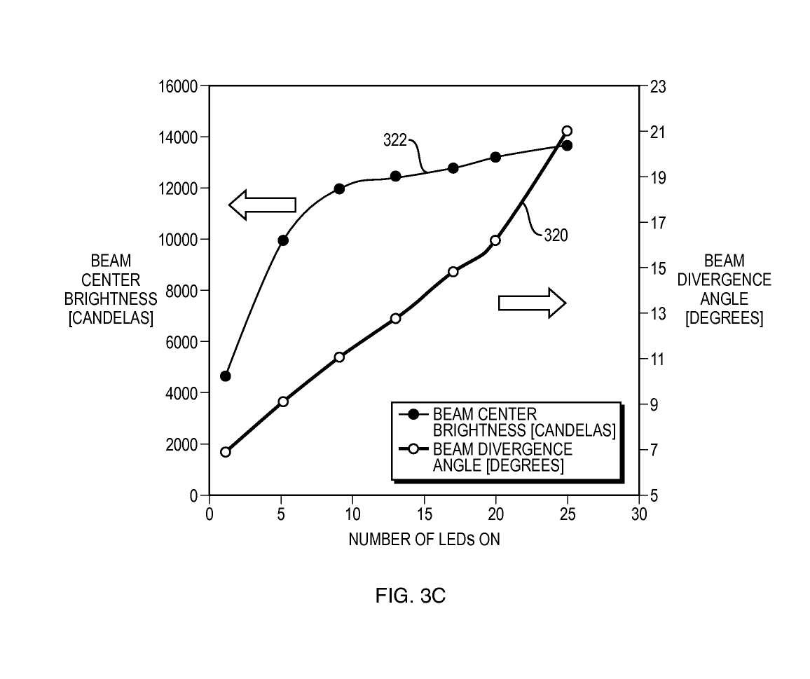

FIGS. 3A-3C quantitatively characterize one embodiment of a variable-beam light source based on computational modeling. The modeled light source includes a 5×5 LED array of Luxeon Z LEDs, placed at the focal plane of a faceted parabolic reflector. FIG. 3A shows a side view of the reflector 300, and FIG. 3B shows a top view of the reflector along with the 5×5 array of LEDs 302. The angular extent of the reflector 300, measured, in a cross-section through the optical axis, as the opening angle θ between a straight line in the focal plane and a straight line connecting the focus with the edge of the reflector's aperture 304, is 70°. The reflector 300 has an opening 306 with a diameter of 1 cm at the entrance surface (where the LEDs are located). Vertical facets each subtend 10°, and azimuthal facets each occupy 6.666° (such that a total of 54 facets cover the full 360° circle). The resulting reflector has a height of 3.2 cm and a radius of 1.85 cm.

In a series of calculations, the LEDs were turned off from the outside one by one, and the resulting divergence angle and candela value at the center of the beam (which is a measure of brightness at the center of the beam) were calculated. The results of these calculations are shown in FIG. 3C. The lower curve 320, representing the divergence angle of the beam (right axis), shows that, as the outer LEDs are turned off, the beam angle monotonically decreases from about 21° down to 7°, where only one LED remains lit. As the individual LEDs are turned off successively, the total light output decreases linearly (not shown) since each LED generates, in this model, 100 lumens. However, as can be seen in the upper curve 322, the beam brightness at the center (left axis) remains nearly constant in the range from twenty five LEDs down to about five LEDs, indicating that the bulk of the light is being withdrawn from the outside of the light beam. Thus, from the user's perspective, the object being illuminated remains at about the same brightness while the surrounding region becomes darker.

Light sources in accordance herewith need not necessarily employ parabolic reflectors, but may, generally, use any concave reflector. For example, in some embodiments, the reflective surface is shaped like a portion of a sphere, cone, ellipsoid, or hyperboloid, or in a manner that does not correspond to any geometric primitive. Non-parabolic reflectors generally do not possess a unique focal point where all reflected rays originating from a collimated incident beam intersect, but direct the reflected rays towards the same region; the brightest point within this region is herein regarded the focus of the reflector. The absence of a unique focal point may contribute to the divergence of the beam and/or the blurring of non-uniformities in the intensity distribution of the LED arrangement (or other extended light-emitting surface). Notwithstanding this inherent “mixing” of light from different LEDs, non-parabolic reflectors may be faceted to further increase the beam divergence and/or quality and uniformity of the output beam.

Furthermore, the LED arrangement need not in all embodiments be placed at a plane through the focus of the optic. In some embodiments, it may be advantageous to move the LED arrangement slightly out of focus, e.g., by 10%, 20%, or 30% of the focal length. Removing the LEDs from the focal plane may further increase the beam divergence and/or help blur the individual LED die. However, if the LEDs are moved too far away from the focal plane, the reflector's function to create a directed light beam may be undermined. Therefore, in typical embodiments, the LED arrangement is place substantially at the focal plane, i.e., no more than about 10% of the focal length away from the focal plane.

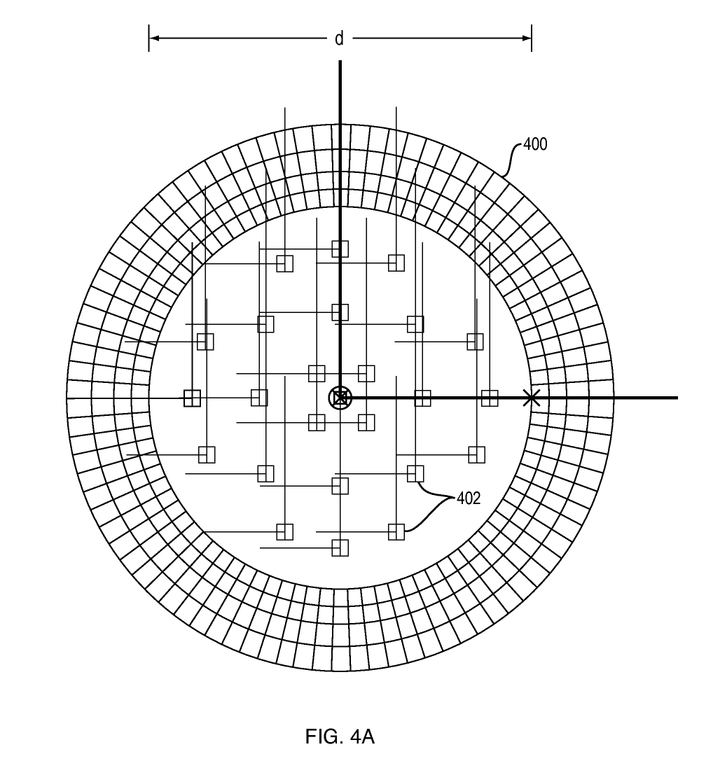

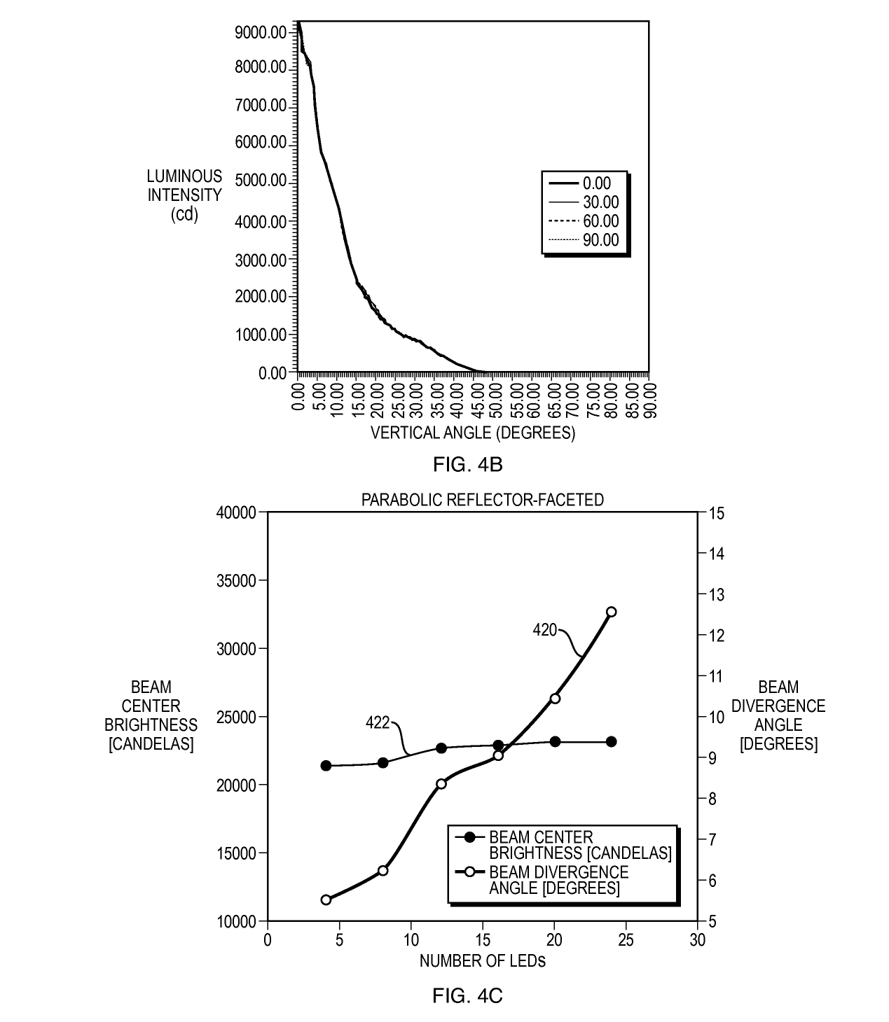

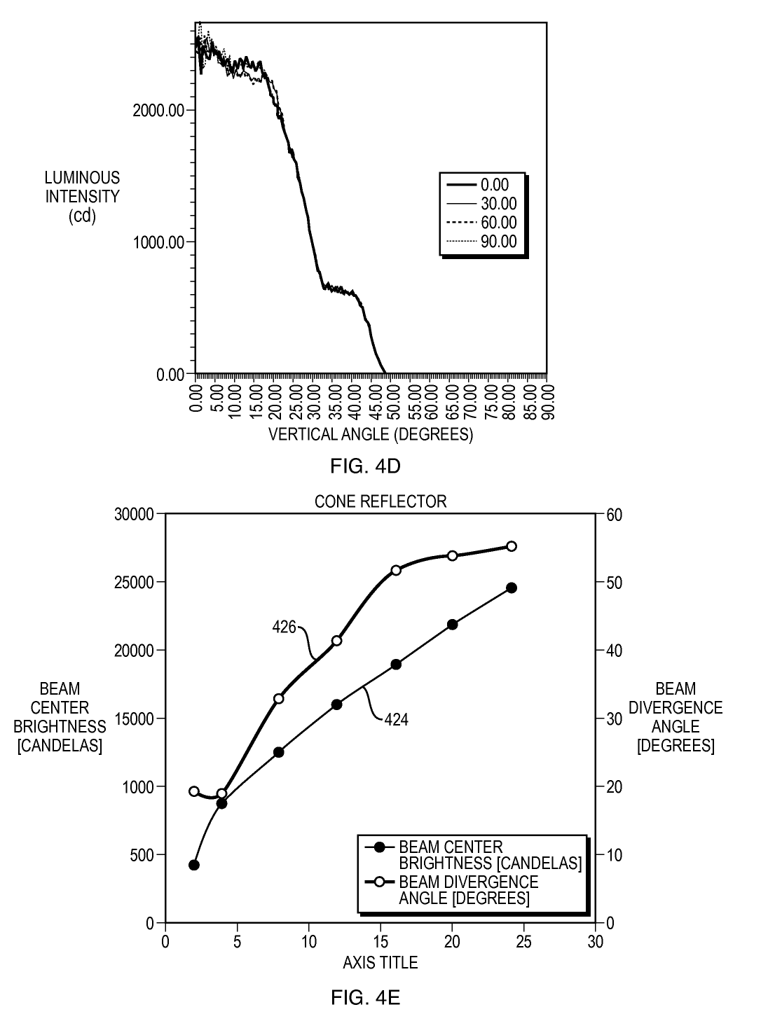

FIGS. 4B-4E provide a comparison between the output beam characteristics achieved with parabolic and conical reflectors, respectively; the shown data is based on computational modeling. FIG. 4A shows the arrangement 400 of LEDs underlying these calculations; herein, twenty-four LEDs 402 are arranged along three concentric, approximately circular closed curves, with four LEDs on the central circle, eight LEDs on the middle circle, and twelve LEDs on the outer circle. The diameter of the LED arrangement is approximately 12 mm, and the LEDs are placed in the focal plane of the optic. FIG. 4B illustrates the intensity profile of the output beam created with a faceted parabolic reflector having an opening angle 8 of about 70° divided into fourteen facets of 5° each, with 54 azimuthal facets and a focal length of about 3 mm; the luminous intensity is plotted against the angle relative to the optical axis. As can be seen, the intensity gradually falls off from a peak intensity at the optical axis towards zero at about 45°, following approximately a Lambertian distribution. The beam divergence, i.e., the full width of the beam between the points of half-maximum intensity on either side of the optical axis, is approximately 20°. The lack of smoothness in the curve is due to the non-uniform intensity of the LED array and the facets. FIG. 4C shows the beam divergence 420 and center beam brightness 422 plotted against the number of LEDs that are turned on (starting from the inner-most circle and moving outward). The angle of divergence increases proportionately to the number of active LEDs, achieving an overall beam-angle variation of about 3:1. The center beam intensity is substantially constant (i.e., varies, in this embodiment, by less than about 10%).

FIG. 4D shows, for comparison with FIG. 4B, the intensity profile generated with a conically shaped reflector (and the same LED arrangement); the reflector has an opening angle (measured between the optical axis and the surface of the cone) of about 53°, an entry surface of about 25 mm in diameter, an aperture about 40 mm in diameter, and 54 azimuthal facets. Here, the luminous intensity as a function of the angle relative to the optical axis is not as close to Lambertian in shape, but still falls off gradually. More light is distributed away from the center of the beam, resulting in a lower center-beam intensity and a wider beam-divergence angle (which is, in this case, about 60°. FIG. 4E illustrates how the divergence 424 and center-beam brightness 426 change for the conical reflector as LEDs are successively turned on (starting closest to the center of the arrangement). As shown, the beam divergence increases proportionately to the number of LEDs, as with the parabolic reflector. However, unlike the center-beam brightness resulting for the parabolic reflector, the center-beam brightness increases, for the conical reflector, significantly with the number of active LEDs. For some applications, this correlation between increasing peak intensity and increasing divergence may be advantageous. Accordingly, the shape of the reflector may be chosen based on the desired behavior the beam as LEDs are turned on or off, among other criteria (such as ease of manufacturing, beam quality, etc.).

Reflectors for light sources in accordance herewith come in various sizes and with various optical characteristics. The opening angle θ of the reflector typically varies, for practical reasons, between about 20° and about 80°. For parabolic reflectors with a focal length of, for instance, about 3 mm, this range corresponds to aperture diameters ranging from about 17 mm to about 136 mm and to aperture-to-focal-length ratios between about 5.7 (for 20°) to about 48 (for) 80°. Of course, other focal lengths are possible; in typical embodiments, the focal length is on the order of a few millimeters to a few centimeters. The aperture is typically at least three or four times as large as the focal length, facilitating LED arrangements with diameters greater than the focal length (and, of course, smaller than the aperture diameter), which result in significant beam divergence (if all LEDs are activated) and high brightness (since a significant portion of the emitted light is captured by the optic). Note that these desirable ratios between the focal length, the aperture of the optic, and the size of the LED arrangement are generally not achievable in practice with refractive optics.

In addition to changing the beam angle, light sources in accordance with various embodiments also facilitate brightening or dimming the beam as a whole by changing the brightness of all the LEDs (or just the ones that define the desired beam angle), via the drive currents, simultaneously and uniformly. Thus, the drive circuitry may be provided with two controls for adjusting the beam, one that controls beam angle, and another one that controls brightness. Each control may include a user-controlled input element, such as a rotatable knob or a slider, that allows the user to set the desired angle or brightness, and circuitry that controls the drive currents to the individual elements based on the setting of the input element.

Further, while the exemplary embodiments illustrated in FIGS. 2A-2C, 3B, and 4A have LED arrays composed of identical LEDs, the invention is not limited in this way; rather, multiple different types of LEDs, including LEDs of different sizes, power, brightness, or color may be used. The particular selection and arrangement of LEDs may be tailored to specific applications and desired beam profiles and dependencies on beam angle. For example, the fall-off of center beam brightness with beam angle may be controlled, to a large degree, by putting a higher-power LED at the center of the array and driving it at a higher current than the smaller-die LEDs surrounding it. The resulting slightly larger die area may increase the lower limit of the beam angle, but would raise the center beam brightness to a level comparable to that sustained with the smaller LEDs. In light sources with multiple types of LEDs, the control circuitry preferably allows regulating the relative currents to the individual LEDs as a function of die size and position.

In some embodiments, the array may include multiple sets of colored LEDs. With such arrays, white light may be created by using optics that are textured or faceted to cause mixing of the light. Furthermore, by using differently colored LEDs (such as red, green, blue, and yellow LEDs) and powering them so as to create different light outputs of each color and then mixing the colors (e.g., using faceted optics), a broad range of colors may be created for decorative effects.

In certain embodiments, the LED driver is capable of addressing LEDs in a programmable fashion. The driver may be provided with a set of standard programs, and/or facilitate programming by the user. Further, in some embodiments, multiple programs may be run in parallel. For example, one program may serve to successively turn the LEDs on, beginning at the center of the array and moving towards the periphery, to increase beam angle, while another program may power all active LEDs at a constant current that may be varied from near-zero to a maximum value to adjust brightness. Other programs may be used to selectively turn on LEDs in sufficient numbers to create a recognizable illumination pattern. Such patterns may be projected onto surfaces and seen at a great distance. While, for the creation of uniform beams, faceted optics may be advantageous, pattern creation generally relies on accurately imaging and bringing the selected LEDs into resolution such that smooth imaging optics may be preferable.

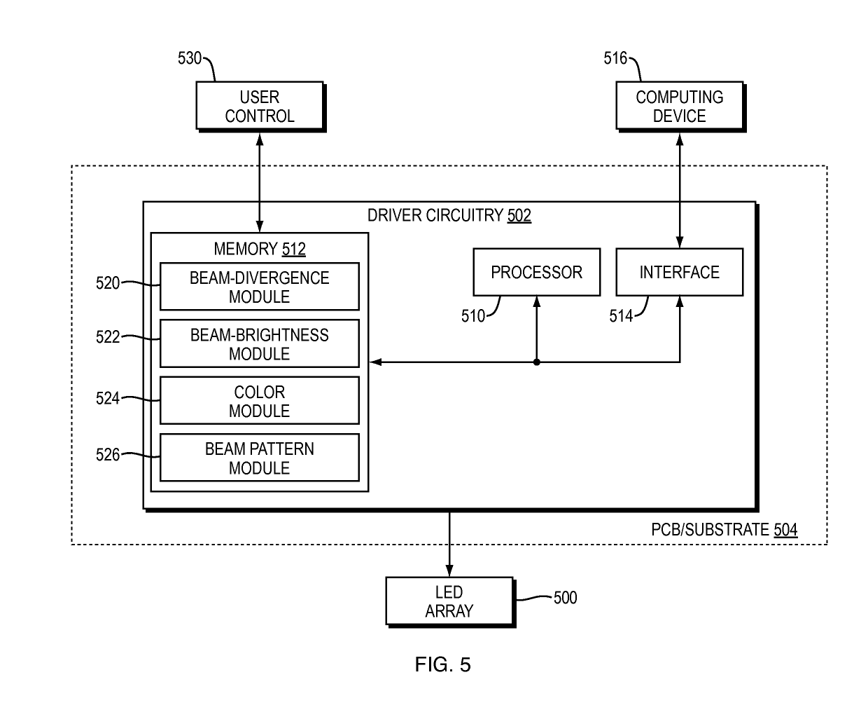

The driver circuitry 120 may generally be implemented in hardware, firmware, software, or any combination thereof. In various embodiments, the driver circuitry 120 is provided by analog circuitry, a digital-signal processor (DSP), a programmable gate array (PGA) or field-programmable gate array (FPGA), an application-specific integrated circuit (ASIC), a microcontroller, or any other kind of processing device. Typically, the driver circuitry 120 is wholly or partially integrated with the LED array 100 in a single structure; for instance, the driver circuitry 120 may be provided on the PCB or semiconductor substrate that carries the LED die. In some embodiments, shown in FIG. 5, the control functionality for the LED arrangement 500 is distributed between driver circuitry 502 on the LED-carrying PCB or substrate 504 and a separate component communicatively connected therewith via a wired or wireless connection. For example, as shown, the light source may include an on-board processor 510 and associated memory 512, as well as a wired or wireless interface 514 (e.g., a RF transceiver) for communicating with an external computing device 516. The memory 512 may store one or more programs, conceptually illustrated as program modules 520, 522, 524, 526, for implementing various functionalities of the light source, such as adjusting the beam divergence, varying the overall brightness of the beam, changing the color profile of the beam (for embodiments that include LEDs of different colors), and/or creating a certain beam pattern, or for implementing a particular functionality in different ways. For example, to gradually increase the beam divergence, the LEDs may be turned on one by one or, alternatively, in groups (e.g., of concentric circular sub-arrangements), generally beginning at the center of the arrangement.

The on-board circuitry may be re-programmed via the external computing device 516, which may, e.g., be a general-purpose computer (typically including a CPU, system memory, one or more mass storage devices, user input/output devices such as a keyboard and screen, and a system bus connecting these components). Alternatively, the light source may be controlled in real-time by control signals sent from the computing device 516 to the on-board driver circuitry 502. Adjustments of the beam divergence and/or other beam property may be responsive to sensor measurements of the illuminated scene or elsewhere in the environment. For example, the drive current to all LEDs may be increased if a decrease in the beam brightness, resulting, e.g., from aging of the LEDs, is observed. Further, to ensure that the LED array is not overheated (which could quickly damage the LEDs), the light source may include a temperature sensor, e.g., a thermistor placed behind the LED-carrying PCB, and the drive currents to the LEDs may be automatically set, by built-in circuitry, so as to not exceed a maximum allowable current for the measured temperature (as may be calibrated and stored, e.g., in the form of a look-up table in the memory 512. When only a few of the LEDs are turned on, the drive currents to these LEDs may be increased since the overall power is lower and the danger of overheating is, thus, reduced. In some embodiments, the light source includes one or more user controls 530, such as manual dials or a keypad, for adjusting the light output; these controls 530 may be provided within or integrated into the same housing that holds the LED arrangement and reflector.

Light sources in accordance herewith may be employed for various purposes and in a various environments. One valuable application is a flashlight that creates a beam with a continuously variable beam angle without requiring movement of optical components. As another example, light sources in accordance herewith may find uses in theaters, museums, and commercial establishments where various scenes are to be created through different lighting. Achieving such different lightings electronically avoids the need for exchanging lights, lenses, and other items, rendering adjustments significantly more convenient and cost-effective; it also allows using feedback, such as camera images of the illuminated scene, to automatically adjust the beam based thereon. Yet another application is the use of light patterns for signaling purposes; for example, an advertisement, or text providing information regarding an emergency situation or conveying a call for help, may be projected onto a building.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. For example, while the invention has been described with respect to embodiments utilizing LEDs, light sources incorporating other types of light-emitting devices (including, e.g., laser, incandescent, fluorescent, halogen, or high-intensity discharge lights) may similarly achieve variable beam divergence if the drive currents to these devices are individually controlled in accordance with the concepts and methods disclosed herein. Accordingly, the described embodiments are to be considered in all respects as only illustrative and not restrictive.

What is claimed is:

1. A light source producing a beam of variable divergence, comprising:
(a) a concave reflecting optic;
(b) an arrangement of light-emitting devices disposed fixedly relative to and oriented to face in the same direction as the reflecting optic, light emitted by the light-emitting devices and reflected by the optic forming a light beam; and
(c) driver circuitry for controlling drive currents to the light-emitting devices individually or in groups thereof to thereby variably control a divergence of the light beam.

2. The light source of claim 1, wherein the arrangement of light-emitting devices is disposed substantially at a focus of the reflecting optic.

3. The light source of claim 1, wherein the light-emitting devices comprise LEDs.

4. The light source of claim 1, wherein the reflecting optic is at least one of faceted or textured.

5. The light source of claim 1, wherein the reflecting optic comprises a parabolic reflector.

6. The light source of claim 5, wherein the arrangement of light-emitting devices is disposed substantially at a focal plane of the parabolic reflector.

7. The light source of claim 1, wherein a diameter of the reflecting optic is greater than a largest dimension of the arrangement of light-emitting devices.

8. The light source of claim 7, wherein the diameter of the reflecting optic is at least twice as large as the largest dimension of the arrangement of light-emitting devices.

9. The light source of claim 1, wherein a largest dimension of the arrangement of light-emitting devices is greater than a focal length of the reflecting optic.

10. The light source of claim 9, wherein the largest dimension of the arrangement of light-emitting devices is at least twice as large as the focal length of the reflecting optic.

11. The light source of claim 1, wherein the circuitry is configured to control the drive currents to the light-emitting devices based on their distance from a center of the arrangement.

12. The light source of claim 11, wherein the circuitry is configured to narrow the beam by providing non-zero drive currents only to light-emitting devices within a specified distance from the center.

13. The light source of claim 1, wherein the circuitry is configured to further uniformly vary the drive currents to all light-emitting devices to thereby vary the intensity of the beam.

14. The light source of claim 1, wherein the circuitry is configured to selectively drive a subset of the light-emitting devices so as to generate a pattern.

15. The light source of claim 1, wherein the circuitry is programmable.

16. The light source of claim 1, wherein the circuitry is configured to control the drive currents based on at least one of sizes or positions of respective light-emitting devices.

17. The light source of claim 1, wherein a light-emitting device located at a center of the arrangement is a higher-power device than a light-emitting device located at a periphery of the arrangement.

18. The light source of claim 1, wherein the arrangement of the light-emitting devices is planar.

19. A method of varying divergence of a light source comprising a concave reflecting optic and, disposed fixedly relative to and oriented to face in the same direction as the reflecting optic, an arrangement of light-emitting devices controllably individually or in groups, the method comprising:
driving the light-emitting devices so as to create a light beam emerging from the focusing optic; and
controlling the drive currents to the light-emitting devices, individually or in groups thereof, based, at least in part, on the distance of the devices from a center of the arrangement so that the beam has a divergence variably determined by the controlled drive currents.

20. The method of claim 19, wherein the light-emitting devices comprise LEDs.

21. The method of claim 19, wherein the reflecting optic comprises a parabolic reflector.

22. The method of claim 19, wherein controlling the drive currents comprises decreasing the drive currents to LEDs in an outer region of the arrangement to thereby narrow the beam.

23. The method of claim 19, further comprising simultaneously and uniformly varying the drive currents to all LEDs to thereby vary the beam brightness.

24. The method of claim 19, further comprising programming driver circuitry controlling the drive currents.
